(19) United States
(12) Patent Application Publication
(10) Pub. No.: US 2008/0195422 A1
(43) Pub. Date: Aug. 14, 2008

(54) CUSTOMIZABLE ORDER PROFILE AND MEDICATION LIST

(75) Inventors: Christopher Nessinger, Kansas City, MO (US); Kevin Sabacky, Kansas City, MO (US)

Correspondence Address: SHOOK, HARDY & BACON L.L.P.;Intellectual Property Department, 2555 GRAND BOULEVARD, KANSAS CITY, MO, 64108-2613, US

(73) Assignee: CERNER INNOVATION, INC., Kansas City, MO (US)

(21) Appl. No.: 11/854,826

(22) Filed: Sep. 13, 2007

Related U.S. Application Data
(60) Provisional application No. 60/932,963, filed on Feb. 9, 2007.

(51) Int. Cl. G06Q 50/00; G06F 17/30

(52) U.S. Cl. 705/3

(57) ABSTRACT

Interactive clinical support instances allowing customizability are provided. Upon identification of a patient, stored clinical information associated with the patient is accessed. Instructions are received from the user regarding presentation of the accessed clinical information. The accessed clinical information is then presented in accordance with at least one of the received presentation instructions. The presented clinical information may relate to acute and/or ambulatory venues of care and include one or more of order, medication, and historical information relating to the patient.

### CROSS-REFERENCE TO RELATED APPLICATIONS

This application claims priority to commonly-assigned U.S. Provisional Application Ser. No. 60/932,963 (Attorney Docket Number CRNI.133059) entitled “CUSTOMIZABLE ORDER PROFILE AND MEDICATION LIST,” filed Feb. 9, 2007, the disclosure of which is hereby incorporated by reference herein.

### STATEMENT REGARDING FEDERALLY SPONSORED RESEARCH OR DEVELOPMENT

Not applicable.

### BACKGROUND

In the ever-changing practice of modern medicine, availability of information plays a fundamental role in clinical environments. Access to information assists clinicians with decision-making and allows clinicians to obtain a wealth of situational information relating to both a patient's previous history and a patient's current treatment scheme. The difficulty for clinicians does not stem from the lack of information available, but rather stems from uncertainty as to how to best access the information.

Over the course of the last decade, a variety of computer-based solutions have been developed to assist clinicians in the care of patients. Such solutions provide clinicians with computerized access to patient information and allow clinicians to manage patient activities. Many of these solutions, however, include cumbersome functionality that hinders a clinician's information access. In particular, some solutions present unnecessary information to the clinician, overwhelming the clinician with too much data and necessitating time-consuming data searching and sifting to uncover the desired information. Additionally, some solutions only present a few aspects of information and omit information that may interest a clinician. As such, a clinician may be required to access information from a variety of solutions to treat the patient. Moreover, similar functions such as ordering a medication may be performed differently in the context of different decision support information depending on the particular solution within which the clinician is operated. Even the most technically savvy clinician is forced to obtain a thorough understanding of each solution for every aspect of interest to realize the benefits of information accessibility. The requisite time investment to learn and operate the systems becomes prohibitive for an already-busy clinician.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to interactive clinical support for clinicians through customizable viewing and manipulation of information. In embodiments of the present invention, a customizable order profile and medication list may be provided with a common view that allows a clinician to efficiently review vast amounts of patient information. Additionally, embodiments of the present invention may leverage the clinical information available in a data store, such as a patient's electronic medical record, to best provide a clinician with information necessary or desired to provide various types of clinical care in various care venues.

### BRIEF DESCRIPTION OF THE DRAWINGS

The present invention is described in detail below with reference to the attached drawing figures, wherein:

FIG. 1 is a block diagram of a computing system environment suitable for use in implementing the present invention;

FIG. 2 is a block diagram of an exemplary system including a customization engine in accordance with an embodiment of the present invention;

FIG. 3 is a flow diagram showing an exemplary method for providing a customizable order profile and medication list, in accordance with an embodiment of the present invention;

FIG. 4A is the first portion of a flow diagram showing an exemplary method for providing a customizable order profile and medication list, in accordance with an embodiment of the present invention, the method having more detail than the method of FIG. 3;

FIG. 4B is the second portion of a flow diagram showing an exemplary method for providing a customizable order profile and medication list, in accordance with an embodiment of the present invention, the method having more detail than the method of FIG. 3;

FIG. 5 is an illustrative screen display showing a customizable order profile and medication list, with a primary grouping by clinical category, in accordance with an embodiment of the present invention;

FIG. 6 is an illustrative screen display showing a customizable order profile and medication list, with a primary grouping by active orders, in accordance with an embodiment of the present invention;

FIG. 7 is an illustrative screen display showing a customizable order profile and medication list, with a primary grouping by date, in accordance with an embodiment of the present invention;

FIG. 8 is an illustrative screen display showing a customizable order profile and medication list, with a primary grouping by encounter, in accordance with an embodiment of the present invention;

FIG. 9 is an illustrative screen display showing a customizable order profile and medication list, with a primary grouping by venue, in accordance with an embodiment of the present invention;

FIG. 10 is an illustrative screen display showing a customizable order profile and medication list, with a primary grouping by clinical category as well as a secondary grouping by date, in accordance with an embodiment of the present invention;

FIG. 11 is an illustrative screen display showing a customizable order profile and medication list, emphasizing various filter properties, in accordance with an embodiment of the present invention;

FIG. 12 is an illustrative screen display showing a customizable order profile and medication list, emphasizing sorting by various column headings, in accordance with an embodiment of the present invention;

FIG. 13 is an illustrative screen display showing a customizable order profile and medication list, emphasizing related results, in accordance with an embodiment of the present invention; and

FIG. 14 is an illustrative screen display showing a customizable order profile and medication list, emphasizing a customizable medication list, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention, among other things, provide computerized methods, systems, and user interfaces configured for customizing order profiles and medication lists. A customizable order profile and medication list provides a clinician interactive clinical support and customizability in viewing and manipulating order and medication information across the acute and ambulatory venues of care. In addition to order profile and medication information, clinical information in the customizable list also relates to historical patient information. Clinical information can be interactively customized in a variety of applications, as directed by the clinician. The customizable list allows the clinician to choose a primary group based on information the clinician has an interest in reviewing. The grouped clinical information will be presented to the clinician under various primary group headings. Additionally, if the clinician so chooses, the clinician is able to choose a secondary group for sub-grouping clinical information within the primary groups already selected. The customizable order profile and medication list is designed in a manner to allow the clinician to review and navigate information organized according to instructions provided by the clinician.

Embodiments of the present invention further provide a filter option that allows the clinician to limit the amount of clinical information presented. After filtering, the customizable order profile and medication list remains navigable to allow the clinician to access further information, if desired. Still further, embodiments of the present invention provide a sorting option that sorts the presented clinical information, within the selected groups, in ascending or descending order based on icons and/or column headings appearing above the displayed information. Thus, the clinician has control over the display of information such that the clinician can accurately and efficiently obtain and review desired information.

Having briefly described embodiments of the present invention, an exemplary operating environment suitable for use in implementing embodiments of the present invention is described below.

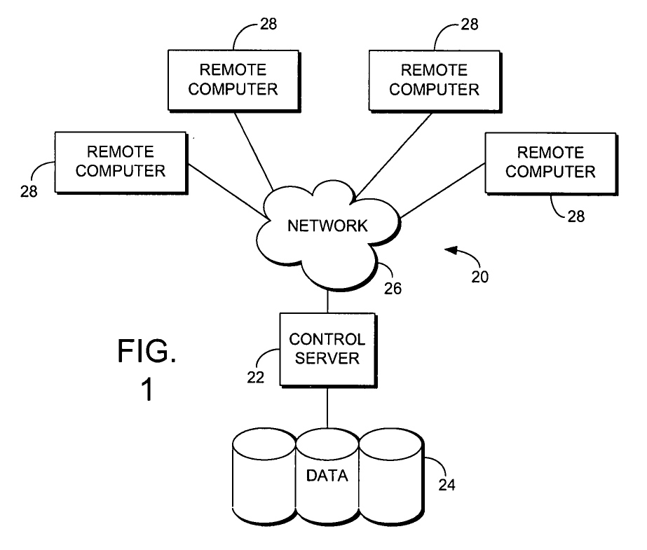

Referring to the drawings in general, and initially to FIG. 1 in particular, an exemplary computing system environment, for instance, a medical information computing system, on which embodiments of the present invention may be implemented is illustrated and designated generally as reference numeral 20. It will be understood and appreciated by those of ordinary skill in the art that the illustrated medical information computing system environment 20 is merely an example of one suitable computing environment and is not intended to suggest any limitation as to the scope of use or functionality of the invention. Neither should the environment 20 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, control server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 20 includes a general purpose computing device in the form of a control server 22. Components of the control server 22 may include, without limitation, a processing unit, internal system memory, and a suitable system bus for coupling various system components, including database cluster 24, with the control server 22. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 22 typically includes, or has access to, a variety of computer readable media, for instance, database cluster 24. Computer readable media can be any available media that may be accessed by control server 22, and includes volatile and nonvolatile media, as well as removable and non-removable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the control server 22. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 24, provide storage of computer readable instructions, data structures, program modules, and other data for the control server 22.

The control server 22 may operate in a computer network 26 using logical connections to one or more remote computers 28. Remote computers 28 may be located at a variety of locations in a medical or research environment, for example, but not limited to, clinical laboratories, hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 28 may also be physically located in non-traditional medical care environments so that the entire health care community may be capable of integration on the network. The remote computers 28 may be personal computers, servers, routers, network PCs, peer devices, other common network nodes, or the like, and may include some or all of the components described above in relation to the control server 22. The devices can be personal digital assistants or other like devices.

Exemplary computer networks 26 may include, without limitation, local area networks (LANs) and/or wide area networks (WANs). Such networking environments are commonplace in offices, enterprise-wide computer networks, intranets, and the Internet. When utilized in a WAN networking environment, the control server 22 may include a modem or other means for establishing communications over the WAN, such as the Internet. In a networked environment, program modules or portions thereof may be stored in the control server 22, in the database cluster 24, or on any of the remote computers 28. For example, and not by way of limitation, various application programs may reside on the memory associated with any one or more of the remote computers 28. It will be appreciated by those of ordinary skill in the art that the network connections shown are exemplary and other means of establishing a communications link between the computers (e.g., control server 22 and remote computers 28) may be utilized.

In operation, a user may enter commands and information into the control server 22 or convey the commands and information to the control server 22 via one or more of the remote computers 28 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the control server 22. In addition to a monitor, the control server 22 and/or remote computers 28 may include other peripheral output devices, such as speakers and a printer.

Although many other internal components of the control server 22 and the remote computers 28 are not shown, those of ordinary skill in the art will appreciate that such components and their interconnection are well known. Accordingly, additional details concerning the internal construction of the control server 22 and the remote computers 28 are not further disclosed herein.

Although methods and systems of embodiments of the present invention are described as being implemented in a WINDOWS operating system, operating in conjunction with an Internet-based system, one of ordinary skill in the art will recognize that the described methods and systems can be implemented in any system supporting the receipt and processing of healthcare-related orders, particularly, medication orders. As contemplated by the language above, the methods and systems of embodiments of the present invention may also be implemented on a stand-alone desktop, personal computer, or any other computing device used in a healthcare environment or any of a number of other locations.

As previously mentioned, embodiments of the present invention relate to computerized methods, systems, and user interfaces configured for customizing order profiles and medication lists relevant to a particular patient to provide support to clinicians. (The terms “individual”, “person”, and “patient” are used interchangeably herein and are not meant to limit the nature of the referenced individual in any way. Rather, the methods, systems, and user interfaces are equally applicable, for instance, in a veterinary setting. Further, use herein of the term “patient” is not meant to imply any particular relationship between the individual in question and those customizing and/or viewing order profiles and/or medication lists. Further, in embodiments such as the veterinary contexts, “individual”, “person”, and “patient” may be an animal as opposed to a human).

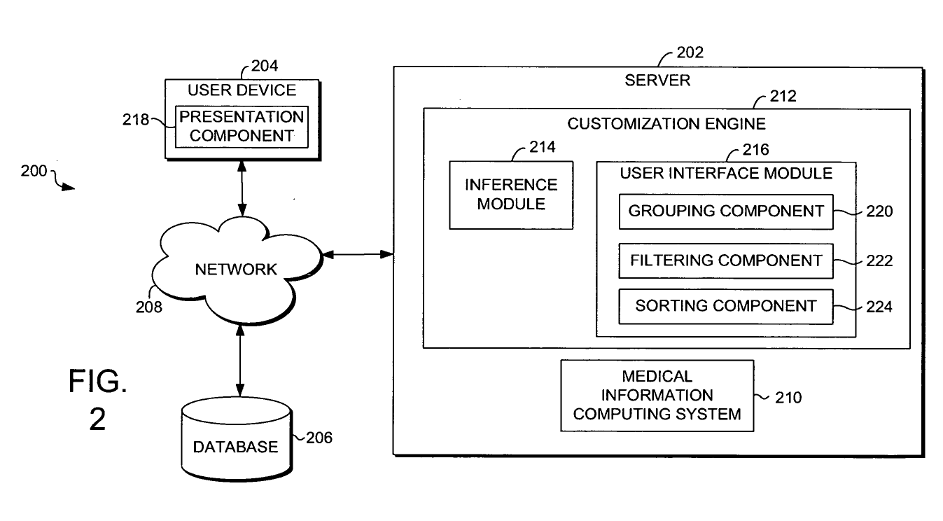

With reference to FIG. 2, a block diagram illustrating an exemplary computing system suitable for use in implementing embodiments of the present invention is shown and designated generally as reference numeral 200. The computing system 200 includes a server 202, a user device 204, and a database 206, all in communication with one another via a network 208. The network 208 may include, without limitation, one or more local area networks (LANs) and/or wide area networks (WANs). Such networking environments are commonplace in offices, enterprise-wide computer networks, intranets, and the Internet. Accordingly, the network 208 is not further described herein.

The database 206 is configured to store information associated with at least one order profile and/or at least one medication list. In various embodiments, such information may include, without limitation, medications, dosages, administration forms, and/or frequencies of administration associated with a plurality of patients, as well as corresponding order profiles. In embodiments, the database 206 is configured to be searchable for one or more of the items of information stored in association therewith. It will be understood and appreciated by those of ordinary skill in the art that the information stored in the database 206 may be configurable and may include any information relevant to an order profile, a medication list, and/or a patient associated therewith. The content and volume of such information are not intended to limit the scope of embodiments of the present invention in any way. Further, though illustrated as a single, independent component, database 206 may, in fact, be a plurality of databases, for instance, a database cluster, portions of which may reside on a computing device associated with the server 202, the user device 204, another external computing device (not shown) and/or any combination thereof.

The server 202 includes a medical information computing system 210, and a customization engine 212. The medical information computing system 210 may be a comprehensive computing system associated with a clinical environment similar to the exemplary computing system 20 discussed above with reference to FIG. 1. The medical information computing system 210 is configured to access information pertaining to a particular patient, for instance, information stored in association with a patient-centric electronic record. The medical information computing system 210 may be configured to access a variety of systems, e.g., clinical laboratory systems, pharmacy systems, radiology systems, hospital administration systems, and the like. Accordingly, the medical information computing system 210 provides a unified computing architecture capable of accessing and aggregating clinical information from a variety of different clinical domains, and providing the order, medication, and historical information to the customization engine 212, as more fully described below. In an embodiment, the medical information computing system 210 may store clinical information from different clinical domains in association with a patient-centric electronic medical record.

In some embodiments, the medical information computing system 210 may include a computerized physician order entry (CPOE) system. A CPOE system allows clinicians to enter healthcare orders, which comprise requests for one or more medication and/or non-medication tasks to be performed for a patient. An order may include, for instance, a request for a procedure, a medication, a laboratory test, an evaluation, a treatment, or a nursing task to be performed.

Information associated with a customization instance may be captured and stored by the medical information computing system 210 with other clinical information, such as, for instance, in a patient's electronic medical record. For example, information that may be captured from a customization instance (more fully described hereinbelow) may include clinical information entered by a clinician during the customization instance and any orders entered based on the customization instance.

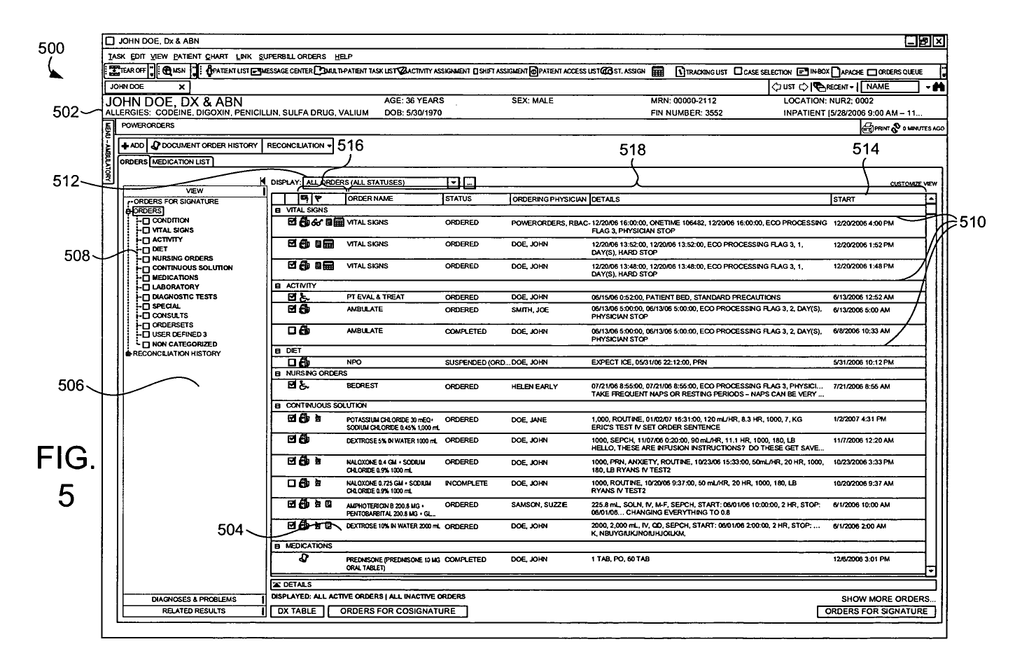

The customization engine 212 is generally configured to provide customizable viewing and manipulation of orders, medications, and historical information relevant to a particular patient to provide support to clinicians. As shown in FIG. 2, the customization engine 212 may include an inference module 214 and a user interface module 216. The inference module 214 is configured to access order, medication, and historical information from a data store, such as data store 206 and/or a data store associated with the medical information computing system 210, for customization instances. Additionally, the inference module 214 communicates with the user interface module 216, which provides for interactive customization instances, as more fully described below with reference to FIGS. 5-14. User interface module 216 may include a grouping component 220, a filtering component 222, and a sorting component 224. Together, grouping component 220, filtering component 222, and sorting component 224 are configured to group, filter, and sort clinical information, providing a customizable presentation. For example, grouping component 220 can group order profile, medication, and historical information relating to a patient in accordance with received instructions.

Computing system 200 permits customization to be provided at the point-of-care via remote computer, e.g., user device 204. Remote computers may be located at, for example, patients' bedsides, nurses' stations, and/or physicians' offices. Accordingly, clinicians may be able to access the customization engine 212 via a remote computer, e.g., user device 204, such that the customization may be provided at the point-of-care. User device 204 includes at least one presentation component 218. Presentation component 218 is configured to present (e.g. display) various clinical information, including order profile, medication, and historical information relating to a patient.

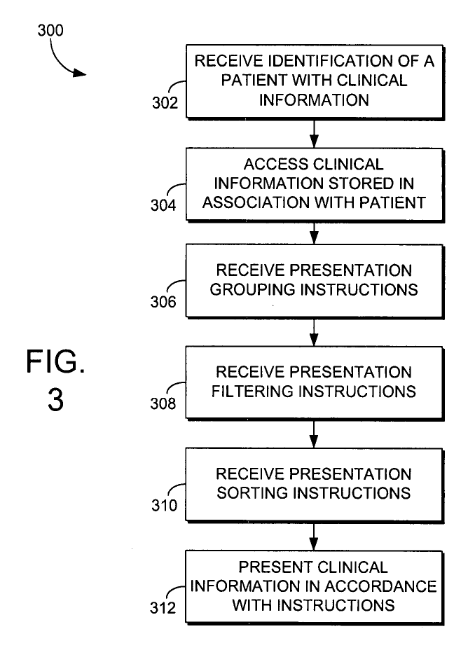

Turning now to FIG. 3, a flow diagram of an exemplary method for providing a customizable order profile and medication list, in accordance with an embodiment of the present invention, is illustrated and designated generally as reference numeral 300. Initially, as indicated at block 302, an identification of a patient with clinical information is received, e.g., via user interface module 216 of the customization engine 212 of FIG. 2. (Once the patient identification is received from the user interface module 216, the clinical information may be obtained by inference module 214 in communication with the medical information computing system 210). By way of example, without limitation, the patient identification may be a selection of a patient from a list of patients.

Next, as indicated at block 304, clinical information stored in association with a patient is accessed, e.g., via inference module 214 in communication with the medical computing system 210 of FIG. 2. By way of example, without limitation, the clinical information may include order profile, medication, and historical information relating to a patient.

Next, as indicated at block 306, presentation grouping instructions are received, e.g., via grouping component 220 of user interface module 216, which is part of customization engine 212 of FIG. 2. As previously discussed, the user may select a primary grouping for the display of clinical information. Additionally, as previously discussed, the user may select a secondary grouping configured to group clinical information within the primary grouping. In various embodiments the grouped information is displayed with primary and secondary group headings indicating the categorization of clinical information.

Next, as indicated at block 308, presentation filtering instructions are received, e.g., via filtering component 222 of user interface module 216 of FIG. 2. As previously discussed, the user may select a filtering action in order to reduce the amount of clinical information displayed so that a clinician may more efficiently obtain desired information. For example, without limitation, if a clinician is only interested in order profile events or medication events within the last week, the clinician is able to limit the displayed clinical information to only those order profile events and medication events occurring within the last week.

Next, as indicated at block 310, presentation sorting instructions are received, e.g., via sorting component 224 of user interface module 216 of FIG. 2. As previously discussed, the user may desire to sort the displayed clinical information according to the existence of icons and/or according to column headings in ascending or descending order. For example, if a clinician is interested in information associated with a particular ordering physician, the clinician may sort by ordering physician and, thus, have more accessibility to the desired information.

Next, as indicated at block 312, clinical information is presented in accordance with the instructions. If desired, the generated display may be presented to the user, e.g., via user interface module 216 and presentation component 218 of FIG. 2. As previously discussed, the user's instructions are implemented into the display of clinical information and the customized organization of information is presented to the user.

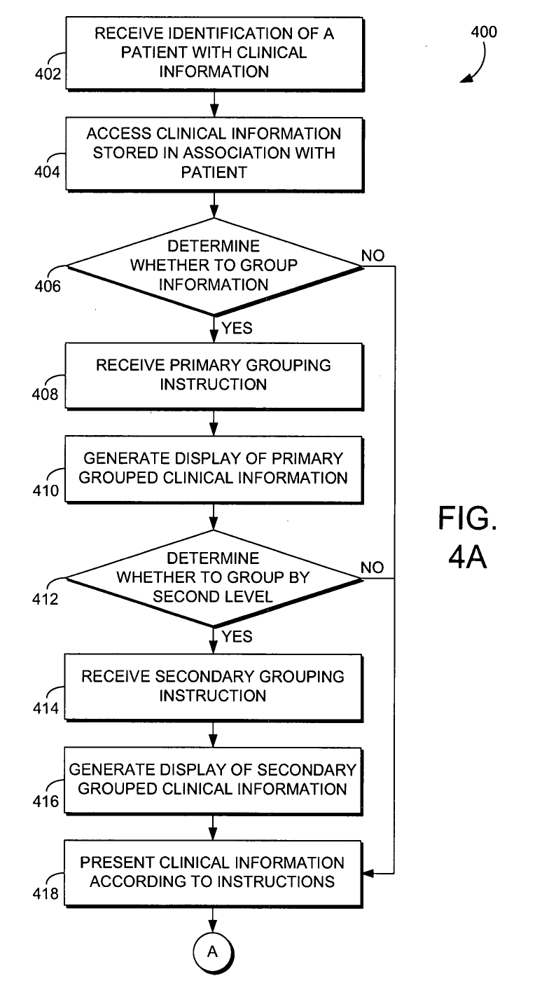

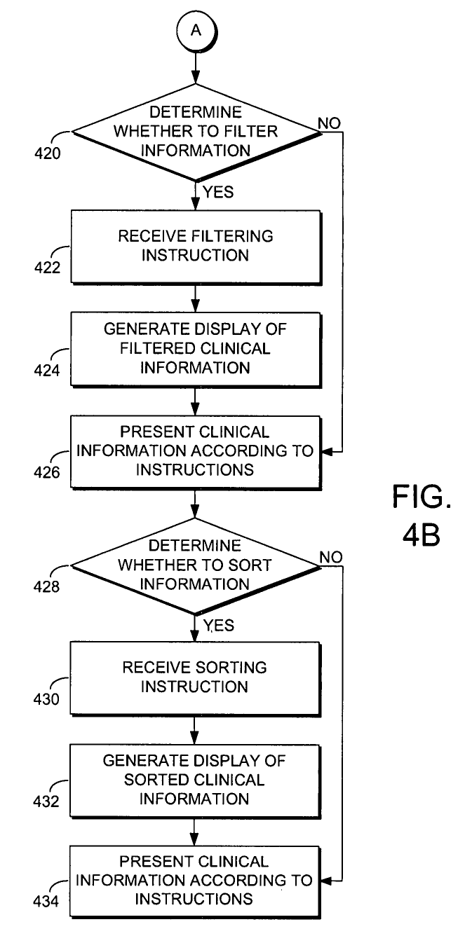

Turning now to FIGS. 4A and 4B, a flow diagram of an exemplary method for providing a customizable order profile and medication list, in accordance with an embodiment of the present invention, is illustrated and designated generally as reference numeral 400. Initially, as indicated at block 402, identification of a patient with clinical information is received as previously discussed with reference to block 302 of FIG. 3. Next, as indicated at block 404, clinical information stored in association with the patient is accessed, as previously discussed with reference to block 304 of FIG. 3.

Next, as indicated at block 406, it is determined, based upon a customizable order profile and medication list, whether to group information. If it is determined that grouping of the clinical information is desired, primary grouping instructions are received, as indicated at block 408, and a display of primary grouped clinical information is generated, as indicated at block 410. Next, it is determined, based upon the customizable order profile and medication list, whether to group the clinical information based upon a secondary level. This is indicated at block 412. If it is determined that grouping the clinical information based upon a secondary level is desired, secondary grouping instructions are received, as indicated at block 414, and a display of secondary grouped clinical information is generated, as indicated at block 416.

If it is determined at block 406 that grouping of the clinical information is not desired, if it is determined at block 412 that secondary grouping is not desired, or upon generation of a secondary grouped clinical information display, clinical information is presented according to instructions, as indicated at block 418, with appropriate grouping, if applicable. The clinical information is presented as previously discussed with reference to FIG. 3.

Next, it is determined based upon the customizable order profile and medication list whether to filter the clinical information, as indicated at block 420 (blocks 420 through 434 appear of FIG. 4B). If it is determined that filtering of the clinical information is desired, filtering instructions are received, as indicated at block 422, and a display of filtered clinical information is generated, as indicated at block 424. If it is determined at block 420 that filtering of the clinical information is not desired, or upon generation of a filtered clinical information display, clinical information is presented according to instructions as indicated at block 426, with appropriate filtering, if applicable. For instance, without limitation, a clinician may only want to view one week of order profiles. The filter step, as indicated at block 420, allows the clinician to narrow the scope of the clinical information presented.

Next, it is determined based upon the customizable order profile and medication list whether to sort the clinical information, as indicated at block 428. If it is determined that sorting of the clinical information is desired, sorting instructions are received, as indicated at block 430, and a display of sorted clinical information is generated, as indicated at block 432. For example, without limitation, the sorting instructions may be provided by the clinician. By way of example, without limitation, the clinician may choose to sort the clinical information according to ordering physician in order to expedite information review. In this example, the clinical information may be sorted by column headings or by icons (e.g., sorting by whether an icon is associated with a particular clinical information element). If it is determined at block 428 that sorting of the clinical information is not desired, or upon generation of a sorted clinical information display at block 432, clinical information is presented according to instructions as indicated at block 434, with appropriate sorting, if applicable.

Embodiments of the present invention will now be described with reference to FIGS. 5-14, which include exemplary screen displays. It will be understood and appreciated by those of ordinary skill in the art that the screen displays of FIGS. 5-14 are provided by way of example only and are not intended to limit the scope of the present invention in any way.

Referring to FIG. 5, a screen display is provided illustrating a customizable order profile and medication list, with a primary grouping by clinical category, in accordance with an embodiment of the present invention. A customizable user interface 500 is generated for providing clinicians customizability in viewing and manipulating clinical information across the acute and ambulatory venues of care. The customizable user interface 500 generally includes a patient information (or demographics) area 502, a clinical information area 504, a clinical overview area 506, one or more primary groups 508, one or more primary group headings 510, a filter selection area 512, one or more sort categories 514, one or more icons 516, and one or more column headings 518.

General patient information is provided in the patient information area 502 to indicate the particular patient being evaluated. The clinical information area 504 includes clinical information elements relevant to the patient. As shown in FIG. 5, clinical information accessed from the patient's electronic medical record has been populated as clinical information elements of the customizable user interface 500. For example, a nursing order of bed rest has been ordered by ordering physician Helen Early. The clinical information area 504 may include one or more primary groups 508 associated with primary group headings 510. In various embodiments, the one or more primary groups are configured to receive at least one primary grouping instruction directed to group customization of the clinical information.

The clinical overview area 506 presents an indication of the clinical information available for the patient currently being evaluated. In the present example of the customizable user interface 500, the clinical overview area 506 includes primary groups 508 organized according to clinical category. The various clinical categories available may include, among other things, condition, vital signs, activity, diet, nursing orders, continuous solutions, medications, laboratory, diagnostic tests, special, consults, order-sets, and user defined categories. Non-categorized information may be presented as well. Thus, a clinician using the customizable user interface 500 can customize the clinical overview area 506 to limit the display to that information which the clinician is seeking. When one of the primary groups 508 of the clinical overview area 506 appears in bold font (or otherwise visually distinguished), at least one corresponding entry is present in the clinical information area 504. For example, as shown in FIG. 5, the primary group “condition” appears in normal font and there are no entries in the clinical information area 504 corresponding to “condition.” Conversely, the primary group “vital signs” appears in bold font and the clinical information area 504 includes three entries corresponding with “vital signs.” One or more primary group headings 510 appear in the clinical information area 504, and correspond with the one or more primary groups 508 appearing in the clinical overview area 506.

The filter selection area 512 presents the clinician with a variety of ways to filter the clinical information appearing in the clinical information area 504. In various embodiments, the filter selection area is configured to receive at least one filtering instruction directed to filter customization of the clinical information. For instance, the filter selection area includes, but is not limited to, all active medications, all active non-medications, all active orders, all active orders within the past twenty-four hours, all medications (all statuses), all non-medications (all statuses), all orders (all statuses), all orders within the past five days, completed orders, future orders, suspended orders, incomplete orders, and orders that are on hold. Additionally, the filter selection area 412 includes an unlimited number of custom filters that can be configured by a clinician using the customizable user interface 500. For example, in FIG. 5, the all orders (all statuses) filter has been selected and the clinical information area 504 has been populated accordingly.

As illustrated in FIG. 5, the sort selection area 514 includes various column headings oriented above clinical information area 504. In various embodiments, sort selection area 514 is configured to receive at least one sorting instruction directed to sort customization of the clinical information. Sort selection area 514 may include, without limitation, one or more icons 516 and/or one or more column headings 518. Clinical information area 504 can further be modified using either type of sort category included in sort selection area 514. By selecting an icon 516 or a column heading 518, a clinician using the customizable user interface 500 can sort clinical information area 504 according to the sort category included in sort selection area 514 (either ascending or descending) within each primary group heading 510. Thus, the customizable user interface 500 provides a clinician with interactive clinical support with customizable viewing and manipulation of orders, medication and historical information across both the acute and ambulatory venues of care. By using the customizable user interface 500, a clinician can specifically tailor the presentation of information to most effectively and accurately display important clinical information associated with patients.

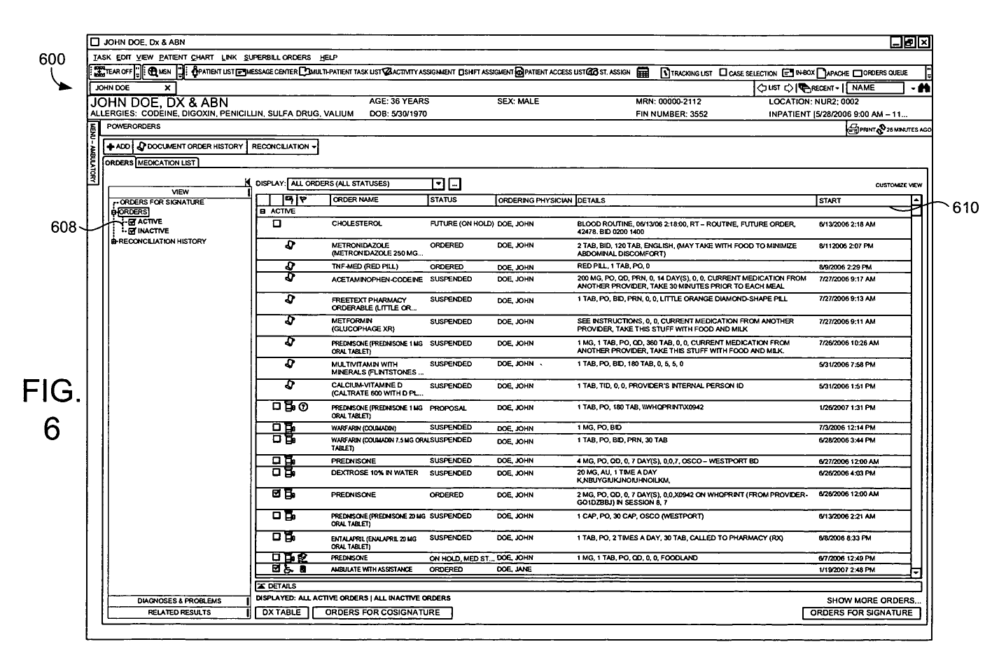

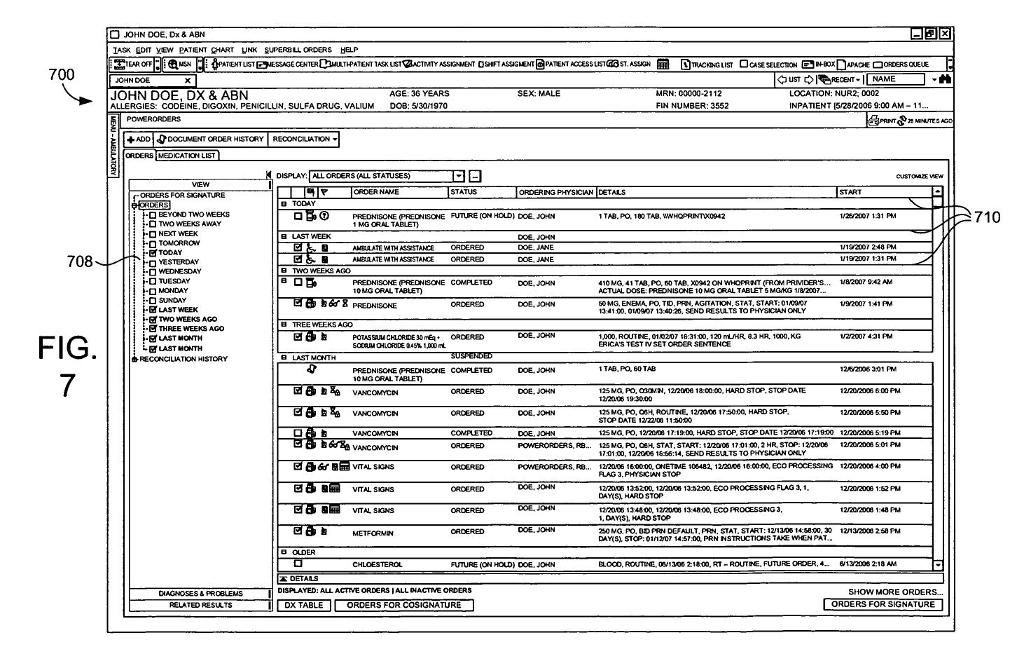

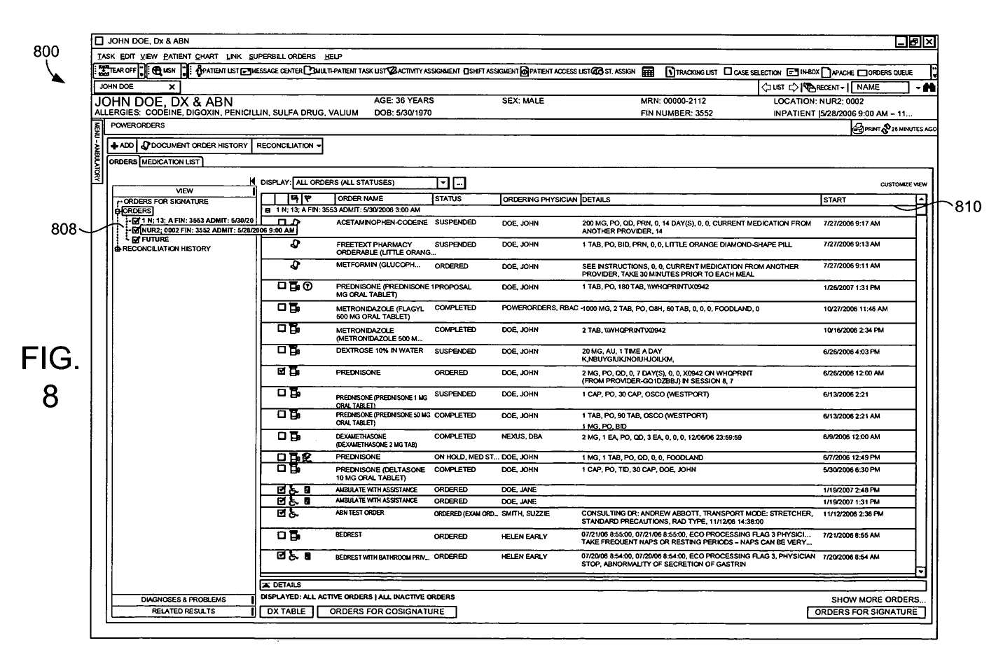

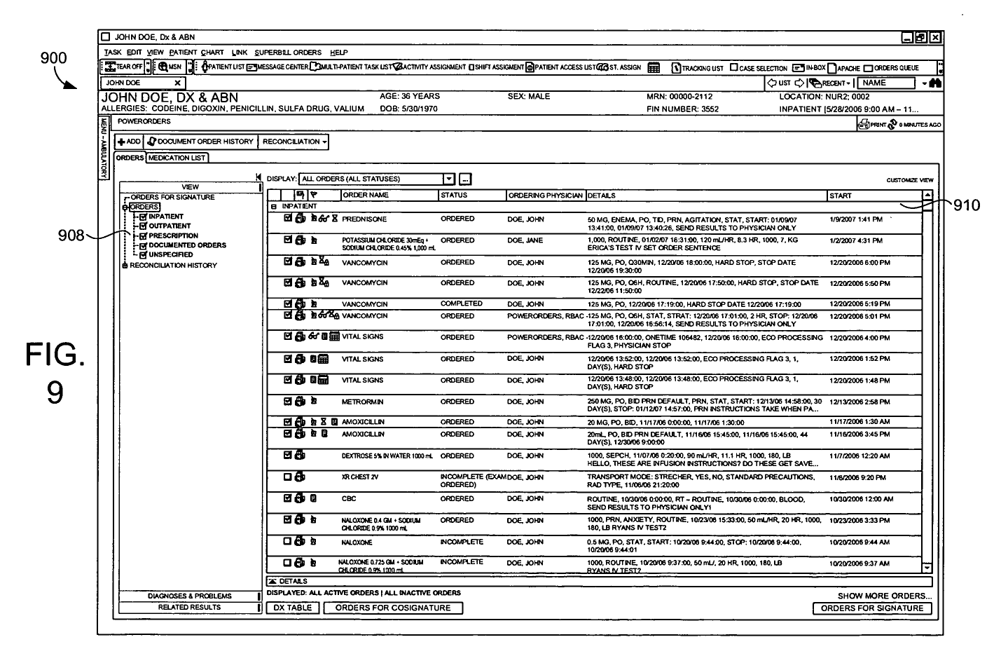

Referring now to FIGS. 6-9, screen displays are provided illustrating customizable order profile and medication lists, with various primary groupings, in accordance with various embodiments of the present invention. With reference to FIG. 6, the customizable user interface 600 is grouped by active orders and inactive orders as illustrated by primary group 608 and primary group heading 610. Similarly, with reference to FIG. 7, the customizable user interface 700 is grouped by date as illustrated by primary group 708 and one or more primary group headings 710. FIG. 8 is an example of customizable user interface 800 grouped by encounter as illustrated by primary group 808 and primary group heading 810. In FIG. 9, the primary group 908 and primary group heading 910 provide an example of a customizable user interface 900 grouped by venue.

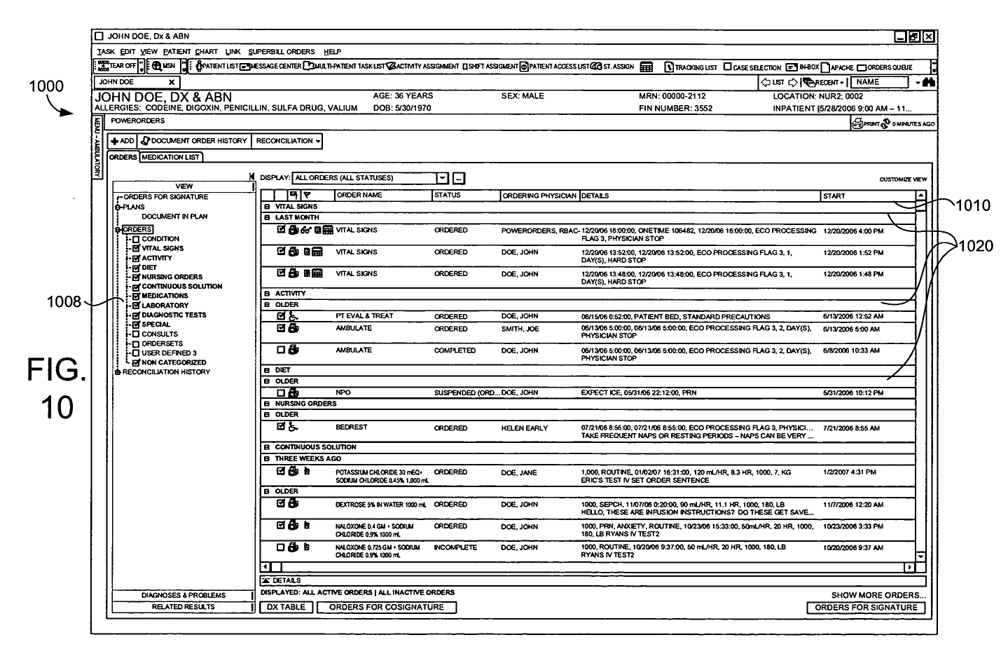

Referring now to FIG. 10, a screen display is provided illustrating a customizable order profile and medication list, with a primary grouping by clinical category as well as a secondary grouping by date, in accordance with an embodiment of the present invention. As illustrated in FIG. 10, in addition to the customization features discussed above with respect to FIGS. 5-9, the user of the customizable user interface 1000 can group according to one or more secondary group headings 1020. More specifically, in addition to the primary groups 1008 and the primary group headings 1010, the user can choose to sort the clinical information area 1004 by one or more secondary headings 1020. In various embodiments, secondary groups (not shown; only the secondary headings in the clinical information area 1004 are depicted in this example) are configured to receive at least one secondary group instruction directed toward group customization of the clinical information. For example, as illustrated by FIG. 10, a clinician using the customizable user interface 1000 can initially group clinical information displayed in the clinical information area 1004 by a primary group heading (here the primary group heading is clinical category) and then create a secondary group, within each primary group, with secondary group headings 1020 (here the secondary group heading is by date). Thus, the clinician using the customizable user interface 1000 has significant flexibility to organize clinical information such as orders, medications, and historical information, in a format that permits clinicians to quickly and accurately obtain important patient data.

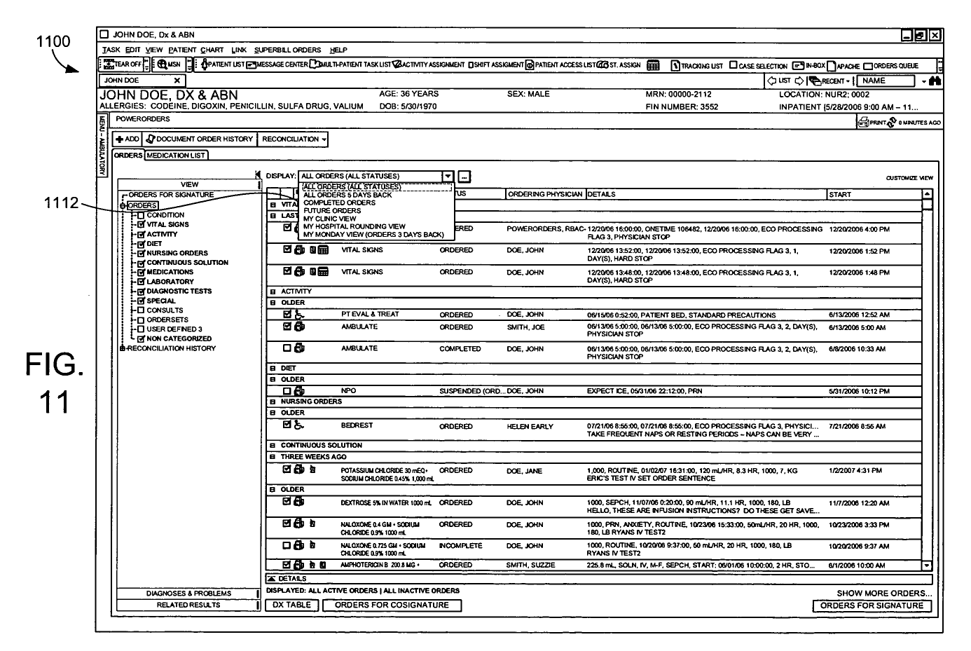

Referring now to FIG. 11, a screen display 1100 is provided illustrating a customizable order profile and medication list and further illustrating various filter properties, in accordance with an embodiment of the present invention. As illustrated in FIG. 11, and as discussed previously with reference to FIG. 5, the user of the customizable user interface 1100 can filter clinical information according to various pre-set filter selections provided in the filter selection area 1112. FIG. 11 provides an illustration of filter selection area 1112 displaying a drop-down menu of available filters for selection. As illustrated, the user may choose to display all orders, all orders within 5 days, completed orders, etc. Stated differently, the grouping and sorting features previously discussed with reference to FIGS. 5-9 affect how information is organized. The filter feature, on the other hand, affects what information is displayed, allowing the user to limit the display to certain information (e.g., only orders within the past 5 days). The filter selection area is not limited to the illustrated drop-down menu. Instead, in various embodiments, the user has access to an unlimited number of custom filters that can be configured and named according to the user's preferences.

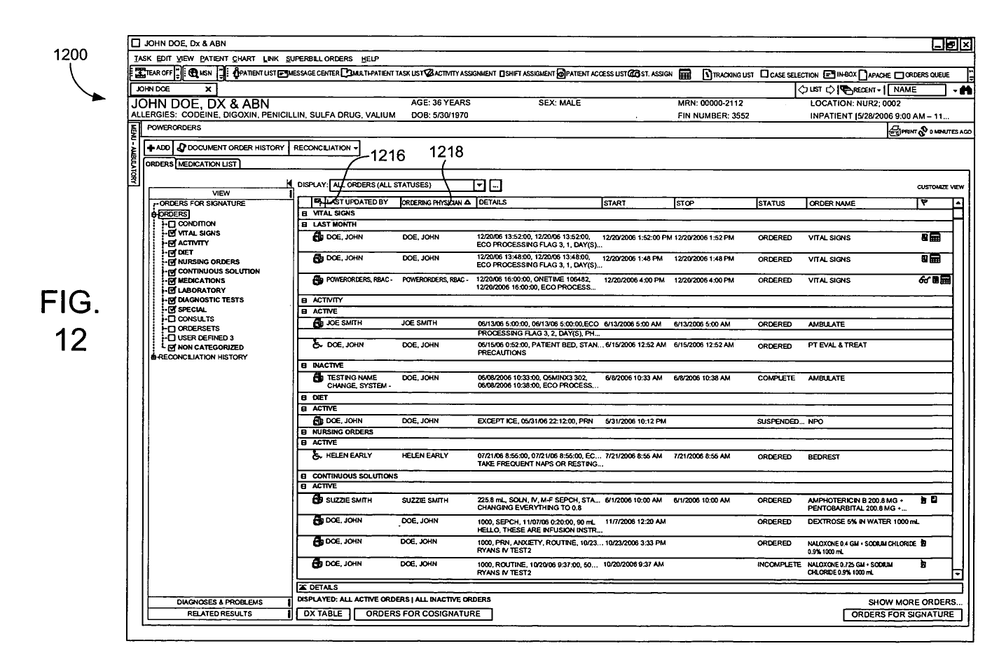

Referring now to FIG. 12, a screen display 1200 is provided illustrating a customizable order profile and medication list, emphasizing sorting by various column headings, in accordance with an embodiment of the present invention. As illustrated in FIG. 12, and as discussed previously with reference to FIGS. 5-9, the user of the customizable user interface 1200 can sort clinical information according to icons 1216 and/or column headings 1218. For example, without limitation, the “ordering physician” column heading 1218, as illustrated in FIG. 12, includes a triangular icon indicating that sorting has been selected for that particular column heading in ascending order.

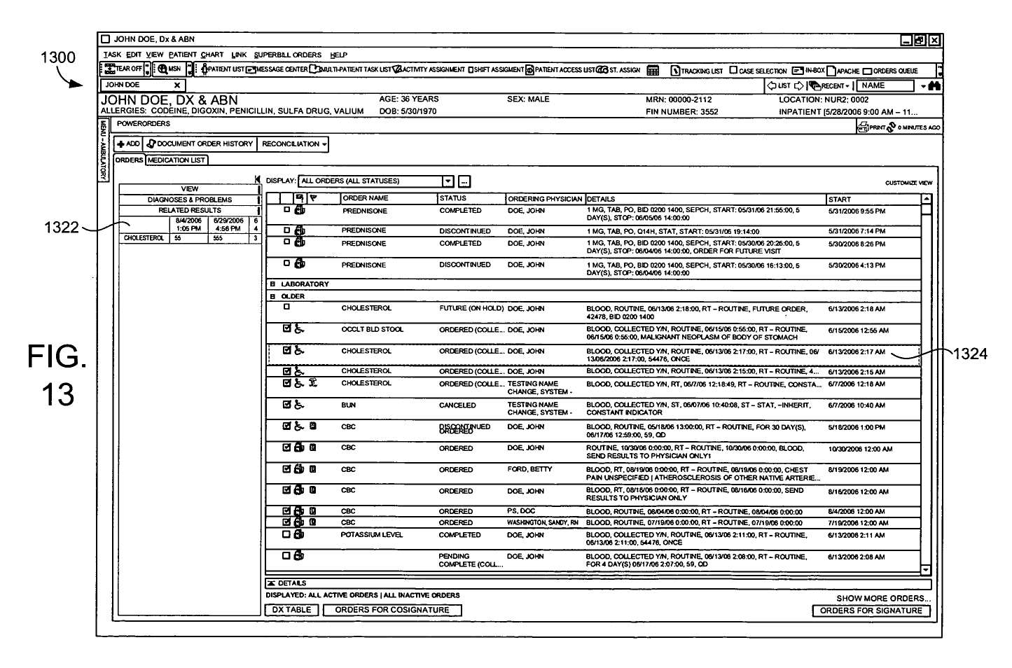

With reference to FIG. 13, a screen display 1300 is provided illustrating a customizable order profile and medication list, emphasizing related results, in accordance with an embodiment of the present invention. As illustrated in FIG. 13, when a single order profile 1324 is selected, a related results overview area 1322 is presented that provides information related to any order or medication. Additional information may also be included in the related results overview area 1322. For example, without limitation, upon selecting an order profile 1324, administration times, next administration times, dispense information for prescriptions, and compliance scores, may be provided in the related results overview area 1322.

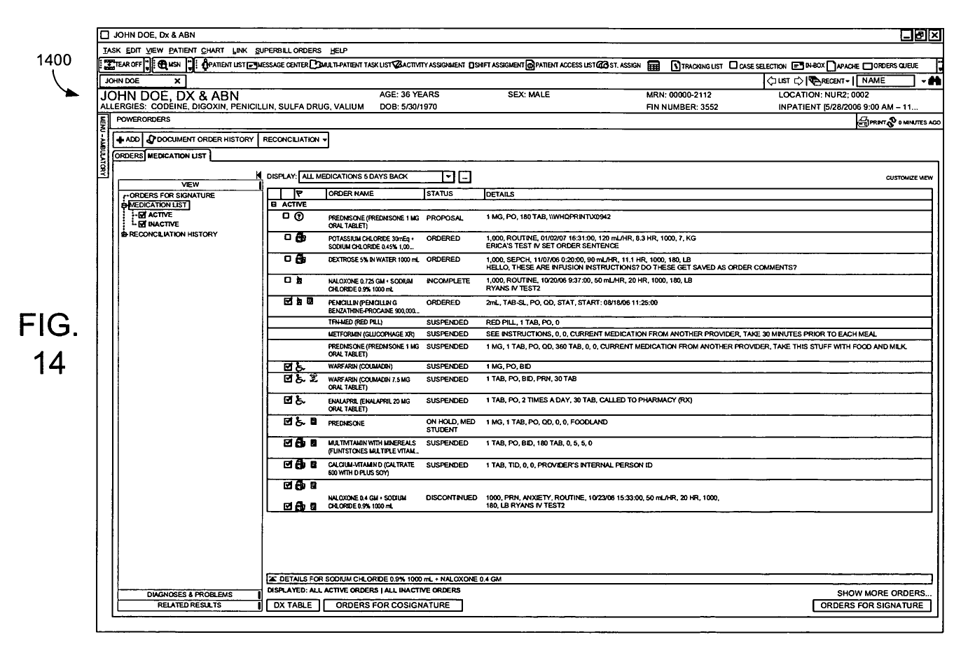

Turning to FIG. 14, a screen display 1400 is provided illustrating a customizable order profile and medication list, emphasizing a customizable medication list, in accordance with an embodiment of the present invention. As illustrated in FIG. 14, in addition to order profile information, medication information and historic information is customizable in accordance with the previous discussion with reference to FIGS. 2-13.

As can be understood, the present invention provides systems, methods, and user interfaces for customizing the display of clinical information across the acute and ambulatory venues of care. Embodiments of the present invention provide interactive clinical support to clinicians through customizable viewing and manipulation of information relating to orders, medications, and historical data. Additionally, embodiments of the present invention may leverage the clinical information available in a data store, such as a patient's electronic medical record, to best provide a clinician with information necessary to various areas of clinical care.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated and within the scope of the claims.

What is claimed is:

1. A method in a clinical computing environment for providing customizable viewing and manipulation of clinical information, the method comprising:
receiving a patient identification;
accessing clinical information stored in association with the patient;
receiving a set of presentation instructions; and
presenting the accessed clinical information in accordance with at least one of the set of presentation instructions, wherein the accessed clinical information includes at least one of an order profile, medication, and historical information relating to the patient.

2. The method of claim 1, wherein receiving a set of presentation instructions comprises:
receiving at least one presentation grouping instruction;
receiving at least one presentation filtering instruction; and
receiving at least one presentation sorting instruction.

3. The method of claim 2, wherein receiving at least one presentation grouping instruction comprises:
determining whether to group the accessed clinical information,
wherein if it is determined that grouping the accessed clinical information is desired, the method further comprises receiving at least one primary grouping instruction indicating a primary level group, and generating a display of the accessed clinical information in accordance with the at least one primary grouping instruction.

4. The method of claim 3, wherein receiving at least one presentation grouping instruction further comprises:
determining whether to group the accessed clinical information by a secondary level; and
if it is determined that grouping the accessed clinical information by a secondary level is desired, receiving at least one secondary grouping instruction indicating a secondary level group and generating a display of the accessed clinical information in accordance with the at least one secondary grouping instruction.

5. The method of claim 4, wherein receiving at least one presentation grouping instruction further comprises:
presenting the accessed clinical information in accordance with the at least one presentation grouping instruction, wherein the accessed clinical information includes at least one of an order profile, medication, and historical information relating to the patient.

6. The method of claim 4, wherein receiving at least one presentation filtering instruction comprises:
determining whether to filter the accessed clinical information; and
if it is determined that filtering the accessed clinical information is desired, receiving at least one filtering instruction and generating a display of the accessed clinical information in accordance with the at least one filtering instruction.

7. The method of claim 6, wherein receiving at least one presentation filtering instruction further comprises:
presenting the accessed clinical information in accordance with the at least one presentation filtering instruction, wherein the accessed clinical information includes at least one of an order profile, medication, and historical information relating to the patient.

8. The method of claim 6, wherein receiving at least one presentation sorting instruction comprises:
determining whether to sort the accessed clinical information; and
if it is determined that sorting is desired, receiving at least one sorting instruction and generating a display of the accessed clinical information in accordance with the at least one sorting instruction.

9. A clinical computing system for providing customizable viewing and manipulation of clinical information, the system comprising:
a medical information computing system configured to access information pertaining to a patient;
a customization engine configured to provide customizable viewing and manipulation of at least one of an order profile, medication, and historical information relevant to the patient; and
a database configured to store information associated with the order profile, medication, and historical information relating to the patient.

10. The system of claim 9, wherein the customization engine comprises:
an inference module configured to access the order profile, medication, and historical information relating to the patient from the database for customization instances; and
a user interface module configured to provide interactive customization instances.

11. The system of claim 10, wherein the user interface module comprises:
a grouping component configured to customize presentation of the order profile, medication, and historical information relating to the patient according to at least one of a primary grouping instruction and a secondary grouping instruction.

12. The system of claim 11, wherein the user interface module further comprises:
a filtering component configured to customize presentation of the order profile, medication, and historical information relating to the patient according to at least one filtering instruction.

13. The system of claim 12, wherein the user interface module further comprises:
a sorting component configured to customize the presentation of the order profile, medication, and historical information relating to the patient according to at least one sorting instruction.

14. The system of claim 9, further comprising a presentation component configured to present the customized order profile, medication, and historical information relating to the patient to one or more physicians.

15. A user interface for providing customizable viewing and manipulation of clinical information, the user interface comprising:
a patient information area configured to present an indication of a patient;
a clinical information area configured to present accessed clinical information relevant to the patient as elements; and
a clinical overview area configured to present general category information related to the accessed clinical information relevant to the patient, wherein the accessed clinical information includes at least one of an order profile, medication, and historical information relating to the patient.

16. The user interface of claim 15, wherein the clinical overview area includes at least one primary group configured to receive at least one primary grouping instruction directed to group customization of the order profile, medication, and historical information relating to the patient, and wherein the clinical information area includes at least one primary group heading configured to customizably organize the order profile, medication, and historical information relating to the patient.

17. The user interface of claim 16, wherein the clinical overview area includes at least one secondary group configured to receive at least one secondary group instruction directed to group customization of the order profile, medication, and historical information relating to the patient, and wherein the clinical information area includes at least one secondary group heading configured to customizably organize the order profile, medication, and historical information relating to the patient.

18. The user interface of claim 16 further comprising:
a filter selection area configured to receive at least one filtering instruction directed to filter customization of the order profile, medication, and historical information relating to the patient.

19. The user interface of claim 16 further comprising:
a sort selection area configured to receive at least one sorting instruction directed to the sort customization of the order profile, medication, and historical information relating to the patient.

20. The user interface of claim 19 wherein the sort selection area includes at least one of a column heading and an icon.
